(19) United States
(12) Patent Application Publication
(10) Pub. No.: US 2015/0184416 A1
(43) Pub. Date: Jul. 2, 2015

(54) MOBILE SHELTER SYSTEM

(71) Applicant: MOBILE MEDICAL INTERNATIONAL CORPORATION, St. Johnsbury, VT (US)

(72) Inventors: Rick Cochran, Walden, VT (US); Kyle Affeldt, Kirby, VT (US); Philip Cantin, Guildhall, VT (US); Justin White, Walden, VT (US); Karl Scott, Hardwick, VT (US); Jeffrey Gates, Hardwick, VT (US)

(21) Appl. No.: 14/453,438

(22) Filed: Aug. 6, 2014

Related U.S. Application Data
(63) Continuation of application No. 13/038,221, filed on Mar. 1, 2011, now abandoned.
(60) Provisional application No. 61/309,112, filed on Mar. 1, 2010.

(51) Int. Cl. E04H 15/06; B62D 63/08; E04H 15/32; B60G 5/02; E04H 15/20; E04H 15/12

(52) U.S. Cl. CPC E04H 15/06; E04H 15/20; E04H 15/12; E04H 15/322; B60G 5/02; B62D 63/08; E04H 2015/206; E04H 2015/201

(57) ABSTRACT

A mobile shelter system having deployed and non-deployed configurations. The shelter system includes a towable trailer and a plurality of functional components for use in the deployed configuration. The functional components include a temperature control unit configured to output one or more of heated and cooled air, and an electric generator configured to provide power to the temperature control unit. In the non-deployed configuration, all of the functional components are positioned on the trailer and the system is configured to be towed over rugged terrain by an off-road vehicle.

### CROSS-REFERENCE TO RELATED APPLICATIONS

This application claims priority from U.S. Provisional Patent Application No. 61/309,112, filed on Mar. 1, 2010, the contents of which are hereby incorporated by inference herein.

### BACKGROUND

1. Field of the Invention

the present invention is generally directed to a shelter system, and more particularly, to a mobile and preferably transportable shelter system.

2. Related Art

Portable shelter systems generally provide self-contained shelters for use in a variety of environments. Such shelter systems often include a tent structure and may be self-contained units providing medical, diagnostic, laboratory and/or communications equipment. These types of shelter systems may be used for military, humanitarian and/or emergency relief applications.

### SUMMARY

In one aspect of the present invention, a mobile shelter system having deployed and non-deployed configurations is disclosed. The shelter system comprises a towable trailer and a plurality of functional components for use in the deployed configuration. The functional components include a temperature control unit configured to output one or more of heated and cooled air, and an electric generator configured to provide power to the temperature control unit. In the non-deployed configuration, all of the functional components are positioned on the trailer and the system is configured to be towed over rugged terrain by an off-road vehicle.

In another aspect of the present invention, a mobile shelter system is disclosed. The system comprises an expandable shelter including at least one inflatable beam, and a multi-stage inflator configured to inflate the at least one inflatable beam. The multi-stage inflator includes a first stage inflator configured to discharge a first volume of a pressurized gas at a first pressure, and a second stage inflator configured to discharge a second volume of the pressurized gas at a second pressure greater than the first pressure, wherein the first volume is greater than the second volume.

In yet another aspect of the present invention, a mobile shelter system having a deployed configuration and a non-deployed configuration is disclosed. The shelter system comprises an expandable shelter having a collapsed state and an expanded state, a temperature control unit configured to provide one or more of heated and cooled air to an interior of the shelter in the expanded state, an electric generator configured to provide power to the temperature control unit, and a fuel powered heater configured to receive fuel stored in the generator and to provide heated air to the interior of the shelter in the expanded state.

In yet another aspect of the present invention, a mobile shelter system is disclosed. The mobile shelter system comprises a towable trailer including a wheel axle assembly comprising a first longitudinal axle support having a first longitudinal axis and a first hole extending transverse the first longitudinal axis and first and second wheels coupled to the first longitudinal axle support. The wheel axle assembly further comprises a lateral axle support extending substantially perpendicular to and rotatably coupled to the first longitudinal axle support such that the first and second wheels move in opposite directions when the first longitudinal axis support rotates about the lateral axle support, wherein a first end of the second axle support extends through and out of the first hole; and a first bracket coupled to the second axle support at a first location on a first side of the first longitudinal axle support and at a second location on a second side of the first longitudinal axle support opposite the first side.

### BRIEF DESCRIPTION OF THE DRAWINGS

Illustrative embodiments of the present invention are described herein with reference to the accompanying drawings, in which:

FIG. 1 is a perspective view of a mobile shelter system in a non-deployed configuration, in accordance with embodiments of the present invention;

FIG. 2 is a side view of the shelter system of FIG. 1 in accordance with embodiments of the present invention;

FIG. 3 is a front view of the shelter system of FIG. 1 in accordance with embodiments of the present invention;

FIG. 4 is a plan view of the shelter system of FIG. 1 in accordance with embodiments of the present invention;

FIG. 5 is a perspective view of the shelter system in a deployed configuration, in accordance with embodiments of the present invention;

FIG. 6 is a side view of the shelter system of FIG. 5, in accordance with embodiments of the present invention;

FIG. 7 is a front view of the shelter system of FIG. 5, in accordance with embodiments of the present invention;

FIG. 8 is a top view of the shelter system of FIG. 5, in accordance with embodiments of the present invention;

FIG. 9 is a schematic diagram of a multi-stage inflator in accordance with embodiments of the present invention;

FIG. 10 is a perspective view of a trailer of a mobile shelter system in accordance with embodiments of the present invention;

FIG. 11 is a schematic diagram of a shelter system having a remote control system, in accordance with embodiments of the present invention; and

FIG. 12 is a perspective view of a wheel axle assembly of a mobile shelter system in accordance with embodiments of the present invention;

FIG. 13 is a side view of the wheel axle assembly of FIG. 12 in accordance with embodiments of the present invention;

FIG. 14 is a front view of the wheel axle assembly of FIG. 12 in accordance with embodiments of the present invention;

FIG. 15 is a cross-sectional view of a portion of the wheel axle assembly of FIG. 14 in accordance with embodiments of the present invention;

FIG. 16 is a perspective view of a wheel axle assembly of a mobile shelter system in accordance with embodiments of the present invention;

FIG. 17 is a perspective view of a portion of the wheel axle assembly of FIG. 16, in accordance with embodiments of the present invention;

FIG. 18 is a side view of a portion of the wheel axle assembly of FIG. 16 in accordance with embodiments of the present invention; and

FIGS. 19 and 20 are perspective views of a scissor jack that may be used with a tow bar of the shelter system in accordance with embodiments of the present invention.

### DETAILED DESCRIPTION

Aspects of the present invention are generally directed to a mobile and preferably transportable shelter system haying a plurality of components that may be used in deploying an expandable shelter, or for controlling the environment of or providing power to an erected shelter, and which are positioned on a towable trailer in a non-deployed configuration of the shelter system. In the non-deployed configuration, the shelter system is towable over rough or rugged terrain by a standard tow vehicle providing the system with ground mobility, and is preferably compact and lightweight, enabling the system to be transported by other modes over longer distances. In certain embodiments, in the non-deployed configuration, the shelter system meets certain volume and/or weight restrictions for air transportation. In some embodiments, the functional components include a temperature control unit and an electric generator.

Specifically, in some embodiments, the shelter system may be used in military, humanitarian, medical and/or emergency relief applications. In certain embodiments, the shelter system may be used as a mobile hospital or care center. In some embodiments, the shelter system include an expandable shelter. In such embodiments, in a deployed configuration, the shelter is in an expanded state and one or more components of the shelter system control the temperature of the interior of the shelter and/or to provide power to components in the shelter. In certain embodiments, the shelter is secured to the trailer in a collapsed state in the non-deployed configuration. In some embodiments, the shelter may be an inflatable air beam shelter. In such embodiments, the shelter system may also include an inflator that may be used to inflate the shelter.

More specifically, in certain embodiments, the shelter system is configured to fit within the footprint of a standard size pallet for air transportation. Additionally, in some embodiments, the trailer includes an axle assembly that facilitates the towing of the shelter system over rough or rugged terrain in the non-deployed mode. Additionally, in some embodiments, the shelter system includes a fuel-powered heater that supplements the heat output of the temperature control unit.

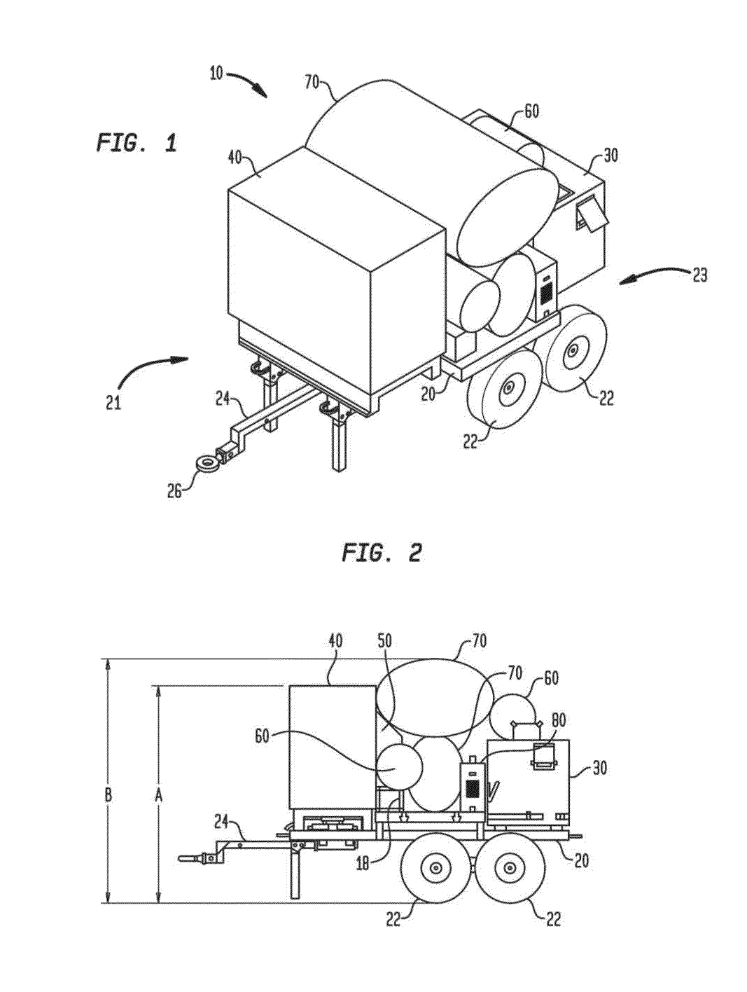

FIG. 1 is perspective view of a mobile shelter system 10 in a non-deployed configuration, in accordance with embodiments of the present invention. FIGS. 2-4 are side, front and plan views, respectively, of shelter system 10 illustrated in FIG. 1, in the non-deployed configuration. In the embodiment illustrated in FIGS. 1-4, shelter system 10 includes a trailer 20 having a support platform on which various components of shelter system 10 may be positioned on or carried by trailer 20. Trailer 20 also includes a plurality of wheels 22 that enable shelter system 10 to move over land. In certain embodiments, the mobility provided by wheels 22 may allow shelter system 10 to reach (or more quickly reach) locations that would be inaccessible or less readily accessible for an immobile shelter system that requires a vehicle large enough to carry the immobile shelter system to transport the system to its final operational location. As discussed below, in some embodiments, trailer 20 includes a wheel axle assembly that facilitates towing of trailer 20 over relatively rough or rugged terrain.

In the embodiment illustrated in FIGS. 1-4, shelter system 10 comprises a plurality of functional components designed to support the operational objectives of the system. These include a generator 30, a temperature control unit (TCU) 40, and an expandable shelter 70. In certain embodiments, shelter system 10 also includes additional functional components, such as a fuel-powered heater 50, and an inflator 80. As used herein, a “functional component” is component that may be used during operation of the shelter system and/or the transition of the mobile shelter system between a non-deployed configuration and a deployed configuration. In some embodiments, functional components may be used in deploying an expandable shelter, or for controlling the environment of or providing power to an erected shelter. In certain embodiments, functional components may include powered and deployable components of the mobile shelter system, such as a generator, temperature control unit, expandable shelter, etc. Additionally, as used herein, the “non-deployed configuration” of a shelter system (which may be referred to herein as a “packed” configuration) is a configuration in which the trailer of the shelter system is configured for towing by a tow vehicle. In certain embodiments, the shelter system is also preferably transportable via another mode of transportation in the non-deployed mode. In the embodiment illustrated in FIGS. 1-4, various functional components of shelter system 10 are positioned on trailer 20 in the non-deployed configuration.

In the embodiment illustrated in FIGS. 1-4, shelter system 10 includes a generator 30 that may provide power to shelter system 10. In certain embodiments, generator 30 may provide power to run various types of lights and electronic equipment within shelter 70, provide power to run inflator 80, and/or provide power to other components of shelter system 10. As shown, generator 30 may be positioned on a rear end 23 of trailer 20. In certain embodiments, generator 30 is a diesel generator. In other embodiments, generator 30 may be a different type of generator. In some embodiments, generator 30 may be, for example, a 6.6 kW diesel generator having the following specifications: 120/240 VAC, a frequency of 60 Hz, a 7.4 gallon fuel tank, and a noise level of 66 dBA at 7 m. In one embodiment, generator 30 includes a grounding kit. In certain embodiments, generator 30 enables shelter system 10 to have power in a remote location so that shelter system 10 is self-sustaining.

In some embodiments, temperature control unit 40 may provide heat, air-conditioning, and/or venting to the inside of shelter 70 when shelter 70 is in an expanded state. In some embodiments, the output of temperature control unit 40 may depend upon the environment in which the shelter system is operational. In certain embodiments, temperature control unit 40 is configured to be electrically connected to generator 30 such that generator 30 powers temperature control unit 40. In some embodiments, temperature control unit 40 is configured to be coupled to shelter 70 for heating or cooling the inside of shelter 70. In the embodiment illustrated in FIGS. 1-4, temperature control unit 40 is positioned on a front end 21 of trailer 20, opposite generator 30 positioned on rear end 23. In some embodiments, temperature control unit 40 is a continuously running temperature control unit 40 that has both heating and cooling capabilities with the following specifications: a 2 ton (24,000 btu/hr) cooling capacity, 5 kW (17,000 btu/hr) of electric heat, and a noise level of 60 dBA at 7 m. In other embodiments, different temperature control units may be used.

In certain embodiments, shelter system 10 includes a fuel-powered heater 50 to supplement the heat output of temperature control unit 40. In some environments, a certain level of heat output may be desired. However, a single conventional temperature control unit capable of producing the desired level of heat output may be too cumbersome to transport to a remote location and/or may be too large to fit within a desired volume or footprint (such as the footprint of a pallet desired for transporting shelter system 10). Accordingly, in certain embodiments, shelter system 10 includes a fuel-powered heater to selectively supplement the output of temperature control unit 40. In such embodiments, the overall size (i.e., weight and/or volume) of temperature control unit 40 and fuel-powered heater 50 may be less than that of a single temperature control unit capable of providing the same level of heat output as temperature control unit 40 and fuel-powered heater 50 together. Fuel-powered heater 50 may be use fuel stored in generator 30. Fuel-powered heater 50 may be smaller in size and/or volume than temperature control unit 40. In certain embodiments, fuel-powered heater 50 may enable shelter system 10 to fit certain size (weight and/or volume) constraints such that shelter system 10 is more easily transportable. In some embodiments, shelter system 10 may fit within the footprint of a standard pallet such that it is easily transportable by air, such as within a helicopter, without compromising the heating capability of shelter system 10. In the embodiment shown in FIGS. 1-4, fuel-powered heater 50 is positioned adjacent to temperature control unit 40 on trailer 10. In certain embodiments, fuel-powered heater 50 is a diesel fired heater which shares diesel fuel with generator 30 and provides 4.8 kW (16,000 btu/hr) of heat.

In some embodiments, shelter system 10 includes a remote control system for activating fuel-powered heater 50. In other embodiments, shelter system 10 includes a remote control system for activating temperature control unit 40. In certain embodiments, shelter system 10 includes a remote control system for controlling both temperature control unit 40 and fuel-powered heater 50. In other embodiments, a wireless control system may be used to activate fuel-powered heater 50. FIG. 11 is a schematic diagram of a shelter system having a remote control system for a fuel-powered heater, in accordance with embodiments of the present invention. FIG. 11 schematically illustrates a trailer 20 including generator 30, temperature control unit 40, fuel-fired heater 50, and a remote control system 200. In such embodiments, remote control system 200 may be used to selectively activate temperature control unit 40 and/or fuel-fired heater 50 via cable 220.

In certain embodiments, shelter system 10 includes a plurality of ducts 60 positioned on trailer 20 in the non-deployed configuration. In some embodiments, ducts 60 are configured to be coupled to temperature control unit 40 and/or fuel-powered heater 50 to transmit temperature regulated air from temperature control unit 40 and/or fuel-powered heater 50 to a desired location. In certain embodiments, temperature control unit 40 and/or fuel-powered heater 50 remain on trailer 20 in the deployed configuration of shelter system 10. In such embodiments, ducts 60 extend between trailer 20 and an adjacent shelter, such as shelter 70 in an expanded state. In certain embodiments, ducts 60 are configured to be coupled to a shelter so that temperature control unit 40 and/or fuel-powered heater 50 may be used to heat and/or cool the inside of the shelter. In some embodiments, ducts 60 are each about 10 feet long. In other embodiments, ducts 60 may have different lengths.

In certain embodiments, shelter system 10 includes a shelter 70. In some embodiments, shelter 70 is an expandable shelter having a collapsed state and an expanded state. In such embodiments, shelter 70, in the expanded state, may be an enclosure that provides a controlled environment to protect against the outdoor elements. In certain embodiments, shelter 70 is a tent. In other embodiments, shelter 70 may be a different type of shelter structure. In the embodiment illustrated in FIGS. 1-4, shelter 70 is shown in a collapsed state in which it is positioned on trailer 20 in the non-deployed configuration of shelter system 10. In the embodiment illustrated in FIGS. 1-4, generator 30 and temperature control unit 40 are positioned on trailer 20 such that shelter 70 in a collapsed configuration may be positioned on the trailer at least partially between generator 30 and temperature control unit 40 in the non-deployed mode. In certain embodiments, shelter 70 may include one or more sections that are each separately rolled up in the collapsed configuration and positioned on trailer 20 in the non-deployed configuration of shelter system 10. In certain embodiments, the entire shelter 70 may be rolled up together in a collapsed configuration. In the embodiment illustrated in FIGS. 1-4, shelter 70 includes two sections that are rolled up separately in a collapsed configuration and are each positioned on the trailer 20.

In certain embodiments, shelter 70 has an inflatable structure and includes a plurality of inflatable beams to support shelter 70 in the expanded state. In such embodiments, portable shelter system 10 may include an inflator 80 which may be used to inflate the inflatable structure (e.g., the inflatable beams) of shelter 70. In the embodiment illustrated in FIGS. 1-4, inflator 80 may be positioned on trailer 20 in the non-deployed configuration. In certain embodiments, inflator 80 may be a self-contained inflator positioned within a box-shaped suitcase, or the like.

In alternative embodiments, shelter system 10 does not include a shelter, but includes other functional components that may be used with an existing tent or other deployable shelter. In such embodiments, shelter system 10 may provide support in the form of power generation, HVAC, compressed air and/or other types of support or systems for use with a pre-existing shelter. In such embodiments, the shelter system may be a mobile and preferably transportable shelter support system.

In the embodiment illustrated in FIGS. 1-4, trailer 20 includes a tow bar 24 having a loop 26 at one end of tow bar 24, which may permit trailer 20 to be readily coupled to a tow vehicle. In certain embodiments, trailer 20 enables shelter system 10 to be moveable by a vehicle over land in a non-deployed configuration. In certain embodiments, trailer 20 enables shelter system 10 to be towable by a tow vehicle such as a motorized cart, an All-Terrain Vehicle (ATV), a Utility Terrain Vehicle (UTV), or another type of off-road vehicle thereby providing shelter system 10 with ground mobility. In such embodiments, the ATV may be a GATOR™ utility vehicle available from John Deere. In other embodiments, shelter system 10 may be towable by a golf cart, or a commercial vehicle, such as a truck. In certain embodiments, tow bar 24 is movable into a more compact position or removable so as to reduce the overall size of shelter system 10 for transportation in the non-deployed configuration. In some embodiments, trailer 20 includes a telescoping tow bar 24 that may telescope inwardly into a reduced profile configuration.

In certain embodiments, it may be desirable for shelter system 10 to meet certain size (volume and/or weight) restrictions. In some embodiments, shelter system 10 is configured to fit within the footprint of a standard-size pallet that may be configured to fit within a certain vehicle, such as a helicopter. In such embodiments, shelter system 10 may be readily transported on the pallet by air to a remote location. In certain embodiments, shelter system 10 may be configured to fit within the allowable volume for the pallet. In some embodiments, the allowable volume for a pallet is approximately 88 inches by approximately 108 inches, with an allowable height of approximately 96 inches above the pallet.

In certain embodiments, shelter system 10 in the non-deployed configuration is sized and configured to be easily transported by air, such as within a helicopter, while towable trailer 20 provides shelter system 10 with mobility over land. In certain embodiments, shelter system 10 may fit within the footprint of a pallet suitable for loading on a helicopter or another type of vehicle that may be used to transport shelter system 10. In some embodiments, shelter system 10, including trailer 20, generator 30 and temperature control unit 40, together weigh less than about 1,400 pounds. In other embodiments, shelter system 10, including trailer 20, generator 30 and temperature control unit 40, together weigh less than about 1,500 pounds. In other embodiments, shelter system 10, including trailer 20, generator 30 and temperature control unit 40, together weigh less than about 1,600 pounds. In certain embodiments, shelter system 10 in a non-deployed configuration, including at least generator 30, temperature control unit 40, shelter 70, ducts 60 and inflator 80 positioned on trailer 20, weighs less than 1,800 pounds, and in other embodiments weighs less than 1,750 pounds. In other embodiments, shelter system 10 in the non-deployed configuration fits within the internal dimensions of a standard size helicopter pallet. In some embodiments, shelter system 10 in the non-deployed configuration fits within the footprint of a 463L Air Cargo Pallet, which may be used within a Boeing CH-47 helicopter or other aircraft. The 463L Air Cargo Pallet extends approximately 88 inches by approximately 108 inches. In certain embodiments, shelter system 10 is configured to fit within a footprint of approximately 88 inches by approximately 108 inches. In some embodiments, shelter system 10 in the non-deployed configuration is configured to fit within the internal dimensions of a helicopter, such as the Boeing CH-47 helicopter and may be moved into the helicopter without a pallet. In such embodiments, for example, a tow vehicle is able to move shelter system 10 into the cargo area of a helicopter where shelter system 10 may be secured within the helicopter.

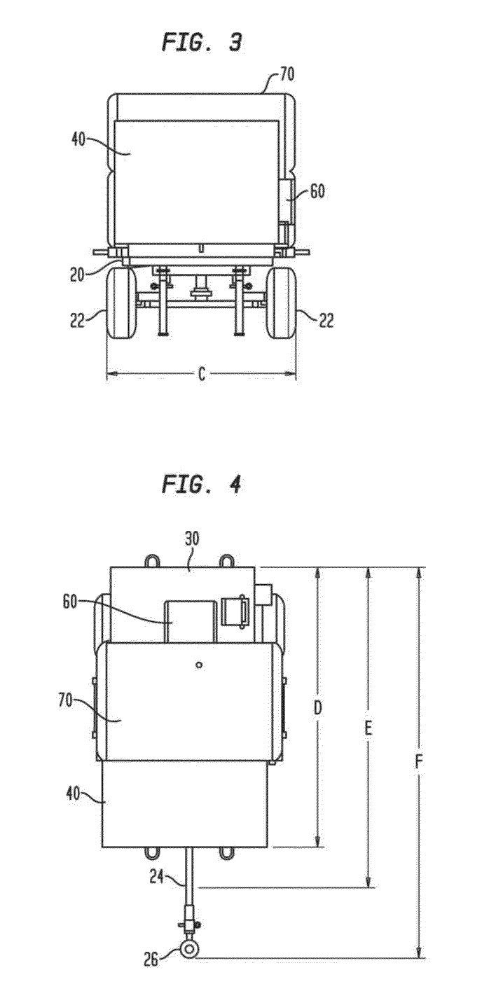

Exemplary dimensions of shelter system 10 in the non-deployed configuration, in accordance with certain embodiments of the present invention, will be described below with reference to FIGS. 2-4. In certain embodiments, the height A of shelter system 10 from the bottom of wheels 22 to the top of temperature control unit 40 (see FIG. 2) is approximately 65 inches. In some embodiments, the height B of shelter system 10 from the bottom of wheels 22 to the top of collapsed shelter 70 (see FIG. 2) is approximately 73 inches. In the embodiment illustrated in FIG. 3, the maximum width C of shelter system 10 is approximately 57 inches. In the embodiment illustrated in FIG. 3, the functional components positioned on trailer 20 do not extend substantially outside of the perimeter of trailer 20. In the embodiment illustrated in FIG. 4, length D of trailer 20 is approximately 84.5 inches. As mentioned above, trailer 20 may include a telescoping tow bar 24. In such embodiments, length F of trailer 20 including telescoping tow bar 24 in its extended towing position is approximately 118.5 inches. In certain embodiments, telescoping tow bar 24 may be retracted, and the length E of trailer 20 (and shelter system 10) with telescoping tow bar 24 retracted is approximately 94.5 inches. In some embodiments, telescoping tow bar 24 may be retracted to place shelter system 10 in an air transportation mode.

In other embodiments, shelter system 10 in the non-deployed mode may have other dimensions. The exemplary dimensions described above are suitable for shelter system 10 in the non-deployed configuration to fit within the internal dimensions (or footprint) of the Boeing CH-47 Chinook helicopter pallet (463L Air Cargo Pallet). In other embodiments, the dimensions of shelter system 10 in the non-deployed configuration may be suitable for shelter system 10 to fit within the internal dimensions of a pallet tor transportation using another vehicle.

In the embodiments illustrated in FIGS. 1-4, a plurality of functional components are positioned on trailer 20 in the non-deployed configuration. In certain embodiments, one or more of these functional components may be removed from trailer 20 such that they are not positioned on trailer 20 in a deployed configuration of shelter system 10. In some embodiments, for example, a tool kit 18 may be positioned on trailer 20, as shown in FIGS. 1-2. Tool kit 18 may include a variety of types of equipment to assemble, repair and/or disassemble shelter system 10. In such embodiments, tool kit 18 may not remain on the trailer in the deployed configuration.

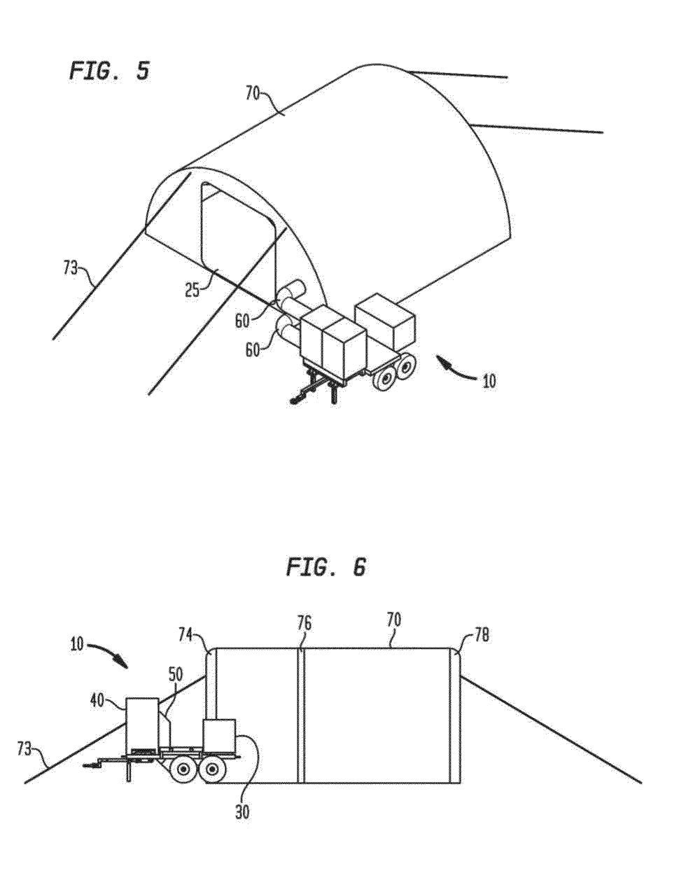

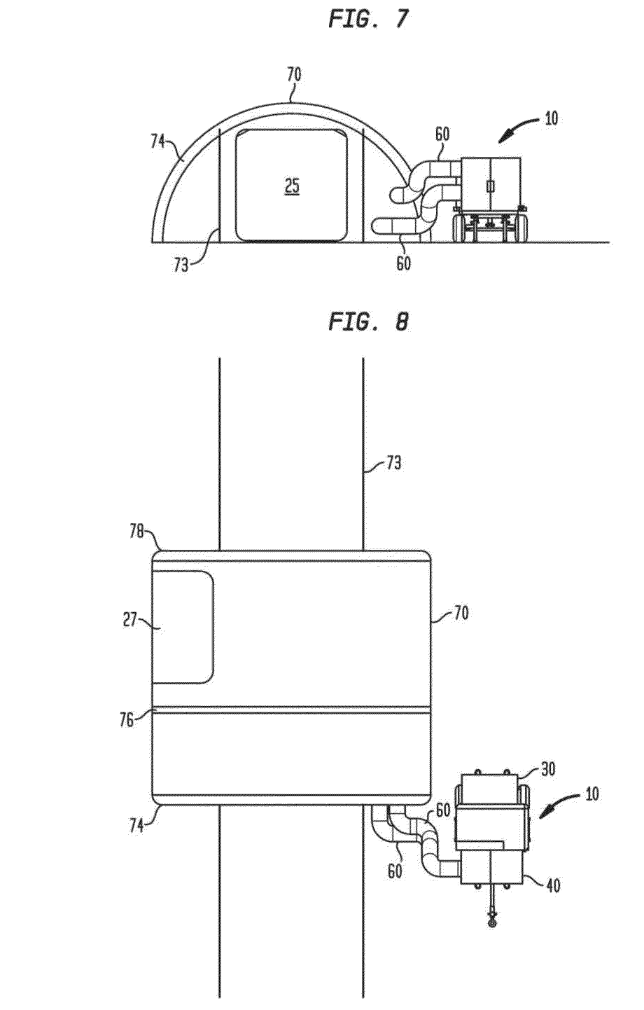

FIG. 5 is a perspective view of shelter system 10 in a deployed configuration, in accordance with embodiments of the present invention. FIGS. 6-8 are side, front and top views, respectively, of shelter system 10 illustrated in FIG. 5 in the deployed configuration, in accordance with embodiments of the present invention. As used herein, a “deployed configuration” is an operational configuration of the shelter system in which one or more functional components of the system are removed from the trailer and/or connected to a shelter. In embodiments of the shelter system that include an expandable shelter, the shelter is in an expanded state in the deployed configuration. In the embodiment illustrated in FIGS. 5-8, generator 30, temperature control unit 40, and fuel-powered heater 50 remain positioned on trailer 20 in the deployed configuration. In addition, shelter 70 is in an expanded state (i.e., set up or deployed). In the embodiment illustrated in FIGS. 5-8, various poles, ropes 73 and stakes may be used in a conventional manner to anchor shelter 70 in place in the expanded state. In certain embodiments, shelter system 10 can be transitioned from the non-deployed to the deployed configuration (e.g., set up) in approximately 6 minutes, and may be transitioned from the deployed to the non-deployed configuration in approximately 8 minutes.

In some embodiments, shelter 70 has an inflatable structure, such as an inflatable frame and/or including inflatable beams. In such embodiments, shelter system 10 may include a manual or automatic inflator for inflating shelter 70. In the embodiment illustrated in FIGS. 5-8, shelter 70 has an inflatable frame that includes inflatable sections 74, 76 and 78. Inflatable sections 74, 76 and 78 are tubular-shaped sections (i.e., air beams) attached to shelter 70 that each, when inflated, form a substantially U-shaped arch for holding shelter 70 in the expanded state. In other embodiments, the tubular frame may be configured differently. In certain embodiments, inflatable sections 74, 76 and 78 may be attached to the outside of shelter 70 or attached to the inside of shelter 70. In some embodiments, inflatable sections 74, 76 and 78 are sewn to shelter 70, whereas in other embodiments, inflatable sections 74, 76 and 78 are integral with shelter 70. In embodiments in which shelter 70 is inflatable, shelter 70 may be configured such that an inflator is only needed to initially inflate the inflatable sections (or air beams). In such embodiments, shelter 70 is not constantly pressurized by an inflator. Embodiments in which shelter 70 is not constantly pressurized by an inflator may be preferable, as an inflator does not continuous utilize energy to maintain the pressure within the shelter. However, in other embodiments, shelter system 10 may include a shelter that is continually pressurized by an inflator while in an expanded state.

In certain embodiments, shelter 70, in the expanded state, is approximately 104.5 inches in height, and approximately 15 feet wide and 16 feet long. In some embodiments, shelter 70 may include one or more doors providing access to the inside of shelter 70 in the expanded state, and may include one or more vented windows (not shown). In the embodiment illustrated in FIGS. 5-8, shelter 70 includes doors 25 and 27. In some embodiments, shelter 70 is a soft-walled shelter, such as a tent, having an approximately 225 square foot interior.

In the embodiment illustrated in FIGS. 5-8, ducts 60 are coupled to shelter 70 in the deployed configuration so that temperature control unit 40 can heat and/or cool the inside of shelter 70, supplemented as necessary by fuel-powered heater 50. In certain embodiments, shelter 70 includes one or more ports which interface with ducts 60. In some embodiments, in the deployed configuration first and second ducts 60 are connected between shelter 70 and temperature control unit 40. In such embodiments, temperature control unit 40 may supply heated or cooled air to shelter 70 via the first duct 60 and the second duct 60 may provide a return path for air from shelter 70 to temperature control unit 40.

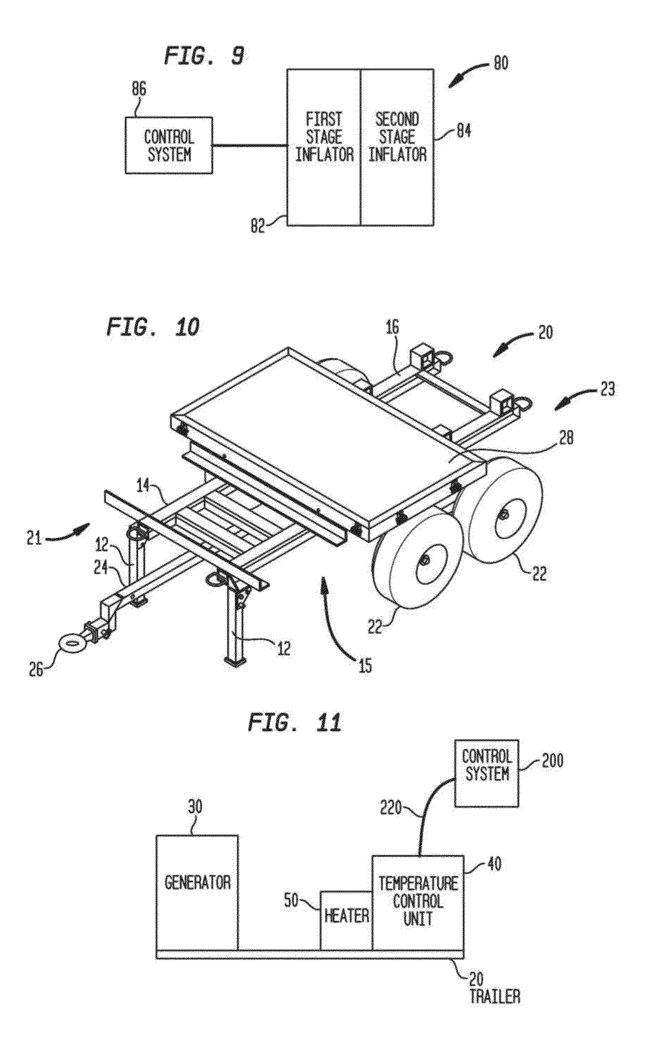

In some embodiments, shelter system 10 includes an inflator 80 for inflating the inflatable frame of shelter 70 or other portions of shelter 70. In the embodiment illustrated in FIGS. 1-4, inflator 80 is configured to be positioned on trailer 20 in the non-deployed configuration. FIG. 9 is a schematic diagram of a multi-stage inflator 80 in accordance with embodiments of the present invention. In the embodiment illustrated in FIG. 9, inflator 80 is a multi-stage inflator including a first stage inflator 82 that discharges a high volume of gas at a low pressure, and a second stage inflator 84 that discharges a lower volume of gas at a higher pressure. In certain embodiments, multi-stage inflator 80 may enable the inflatable frame of shelter 70 to be inflated more quickly than inflating the frame with a one stage inflator. In some embodiments, first stage inflator 82, which discharges a high volume of low pressure gas, may be used initially to inflate the inflatable frame of shelter 70. In such embodiments, due to the high volume of gas discharged, first stage inflator 82 may inflate the frame quickly to erect shelter 70. In some embodiments, multi-stage inflator 80 may switch from operation of first stage inflator 82 to operation of second stage inflator 84 to discharge a lower volume of a gas at a higher pressure to increase the strength of the frame and to complete the inflation of the frame of shelter 70. In some embodiments, inflator 80 is configured to inflate the frame with air, although other pressurized gases may be used in other embodiments. In certain embodiments, first stage inflator 82 is a blower and second stage inflator 84 is a compressor. In some embodiments, first stage inflator 82 is a high volume direct drive blower and second stage inflator 84 is a continuous duty direct drive 20 psi compressor. In other embodiments, inflator 80 is a manual inflation system including a high volume, low pressure pump, and a low volume, high pressure pump.

In the embodiment illustrated in FIG. 9, multi-stage inflator 80 includes a control system 86 that automatically switches between operation of first stage inflator 82 and second stage inflator 84. In some embodiments, control system 86 includes a time-based switch that automatically switches between first stage inflator 82 and second stage inflator 84 after a predetermined time period has elapsed. In such embodiments, the predetermined time period may vary based upon the size of shelter 70 and inflatable frame and based upon the pressure and volume specifications of inflator 80. In certain embodiments, control system 86 automatically switches between first and second stage inflators 82 and 84 after approximately seven minutes. In other embodiments, control system 86 switches between first and second stage inflators 82 and 84 after approximately six minutes, and in still other embodiments, control system 86 switches between the inflators after approximately eight minutes. In other embodiments, control system 86 may switch between the inflators after a greater or lesser amount of time. In alternative embodiments, control system 86 may switch between operation of the first stage inflator 82 and second stage inflator 84 based on criteria other than or in addition to time, such as the pressure within the inflatable frame.

FIG. 10 is a perspective view of trailer 20 of shelter system 10 in accordance with embodiments of the present invention. In the embodiment illustrated in FIG. 10, trailer 20 has four wheels 22 and a telescoping tow bar 24 with a loop 26. In some embodiments, wheels 22 are twenty inch pneumatic tires. In other embodiments, trailer 20 may include other types of wheels 22.

In the embodiment illustrated in FIG. 10, trailer 20 includes a substantially planar support platform 28 upon which one of more functional components of shelter system 10 may rest. In some embodiments, support platform 28 is approximately 33 inches by approximately 56 inches. In certain embodiments, trailer 20 is a flat bed trailer. In other embodiments, trailer 20 may be shaped and configured differently. In some embodiments, trailer 20 may be made of a corrosion resistant material, such as a corrosion resistant aluminum. In the embodiment illustrated in FIG. 10, trailer 20 also includes a frame 15 having frame portions 14 and 16 which may extend forwardly and rearwardly of support platform 28 disposed on frame 15. In some embodiments, front frame 14 is configured to support temperature control unit 40 at front end 21 of trailer 20, and rear frame 16 is configured to support generator 30 at rear end 23 opposite front end 21 of trailer 20. In some embodiments, trailer 20 also includes support beams 12, which may be used to stabilize trailer 20 when stationary. Support beams 12 may pivot or otherwise move into the configuration shown in FIG. 10 to provide an additional contact surface with the ground when trailer 20 is in a stopped position. Support beams 12 may be pivoted upwardly so that they do not contact the ground when trailer 20 is in motion.

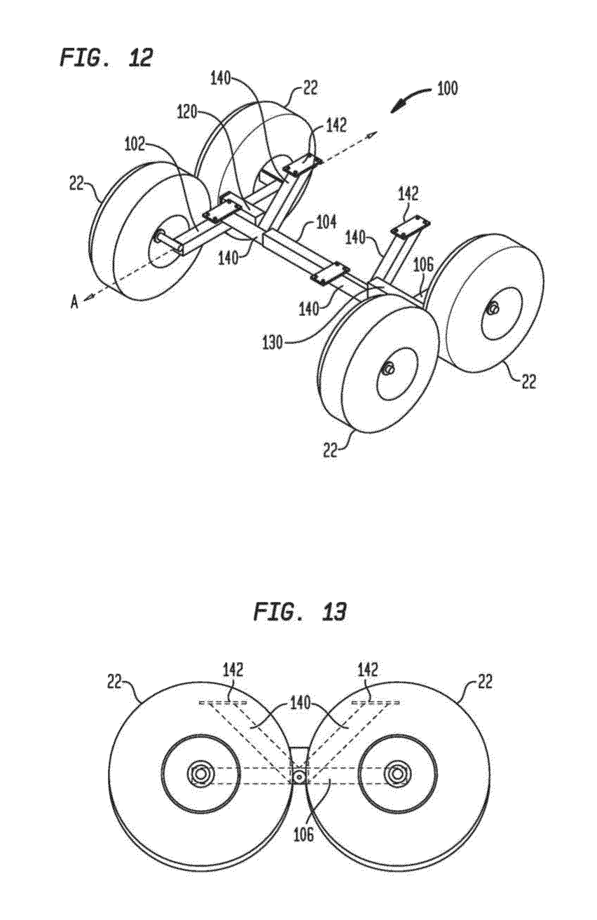

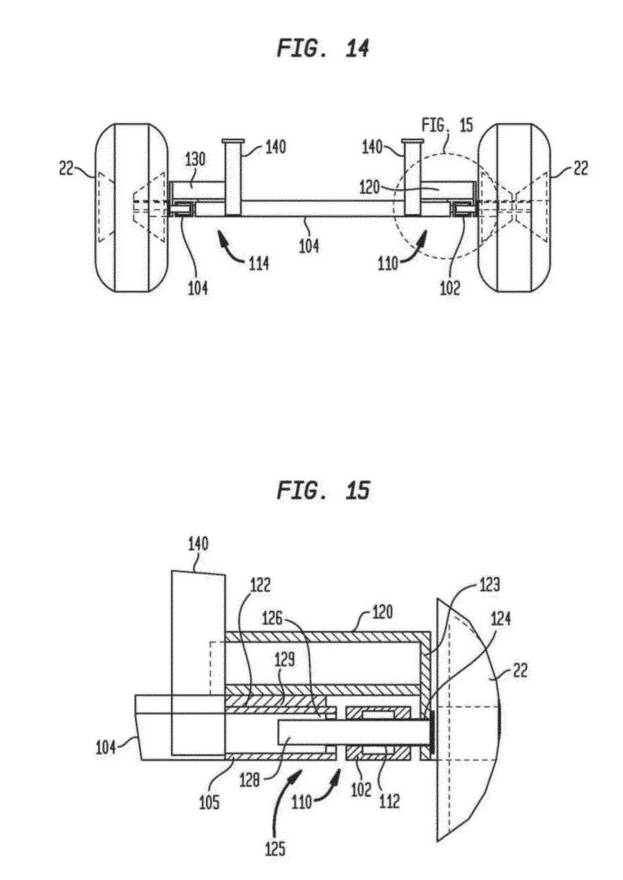

FIG. 12 is a perspective view of a wheel axle assembly 100 for trailer 20 of shelter system 10 in accordance with embodiments of the present invention. FIGS. 13 and 14 are side and front views, respectively, of wheel axle assembly 100 of FIG. 12. FIG. 15 is a cross-sectional view of a portion of wheel axle assembly 100 illustrated in FIG. 14. In certain embodiments, wheel axle assembly 100 is configured to handle rough and rugged terrain that may be encountered when towing shelter system 10 to a remote location in a non-deployed configuration. In the embodiment illustrated in FIGS. 12-15, wheel axle assembly 100 includes a first axle 102, a second axle 104 and a third axle 106 (each of which may be referred to herein as an “axle support”). Two wheels 22 are coupled to first axle 102, and two wheels 22 are coupled to third axle 106. First axle 102 is spaced apart from and substantially parallel to third axle 106, and second axle 104 extends substantially perpendicular to each of first axle 102 and third axle 106.

In the embodiment illustrated in FIGS. 12-15, first axle 102 has a longitudinal axis A and a hole 112 extending transversely of its longitudinal axis. Second axle 104 is coupled to first axle 102 such that first axle 102 may rotate relative to second axle 104, and a first end 110 of second axle 104 extends through and out of hole 112 of first axle 102. As shown in FIG. 15, a first bracket 120 is coupled, via a separation plate 129, to an upper surface of second axle 104 at a first location 122 on a first side 125 of first axle 102. The first location 122 is positioned on a first side of hole 112 in the first axle 102. A portion 123 of first bracket 120 is positioned on a second side 127 of first axle 102 opposite first side 125, and portion 123 is coupled to first end 110 of second axle 104 at a second location 124 on the second side 127 of first axle 102. In some embodiments, first bracket 120 may be substantially U-shaped, and in other embodiments, bracket 120 may have another shape. In certain embodiments, without bracket 120, second axle 104 extends outwardly from first axle 102 in a cantilevered fashion. In some embodiments, by supporting second axle 104 on each side of its connection to first axle 102 using first bracket 120, a more stable arrangement may be provided.

In the embodiment illustrated in FIG. 15, first end 110 has smaller dimensions than other portions of second axle 104. In certain embodiments, first end 110, which extends through hole 112 has smaller dimensions than other portions of second axle 104 which do not extend through hole 112. In certain embodiments, first end 100 has a smaller cross-sectional area (in a plane perpendicular to the length of second axle 104) than portions of second axle 104 that do not extend through hole 112. In the embodiment illustrated in FIG. 15, second axle 104 includes a main portion 105 and a separate component 128 inserted into an opening in main portion 105. First end 110 of second axle 104 is formed by separate component 128. Second axle 104 also includes a plate bushing 126 for coupling component 128 to main portion 105 of second axle 104. In certain embodiments, component 128 is approximately cylindrical.

In the embodiment illustrated in FIGS. 12-15, second axle 104 has a second end 114, similar to first end 110. Second end 114 is coupled to third axle 106 in a manner similar to that described above in relation to first and second axles 102 and 104. More specifically, like first axle 102, third axle 106 also has a longitudinal axis and a hole (not shown) extending transversely of its longitudinal axis. Second end 114 may extend through and out of the hole in third axle 106, and a second bracket 130 may be coupled to second axle 104 on opposite sides of third axle 106, as described above in relation to first and second axles 102 and 104. In certain embodiments, second bracket 130 is substantially the same as first bracket 120.

In the embodiment illustrated in FIGS. 12-15, trailer 20 also includes upwardly extending arms 140 that hold support platform 28 above axles 102, 104 and 106 (see FIG. 10). Each of the plurality of upwardly extending arms 140 is coupled to the second axle 104. In the embodiment illustrated in FIGS. 12-15, arms 140 form approximately V-shaped pairs. A mounting plate 142 is coupled to the upper end of each arm. In certain embodiments, mounting plates 142 assist in securing frame 15 to arms 140. In some embodiments, frame 15 is secured to arms 140, and support platform 28 is secured to frame 15. In certain embodiments, arms 140 and mounting plates 142 enable support platform 28 of trailer 20 to be positioned above wheels 22.

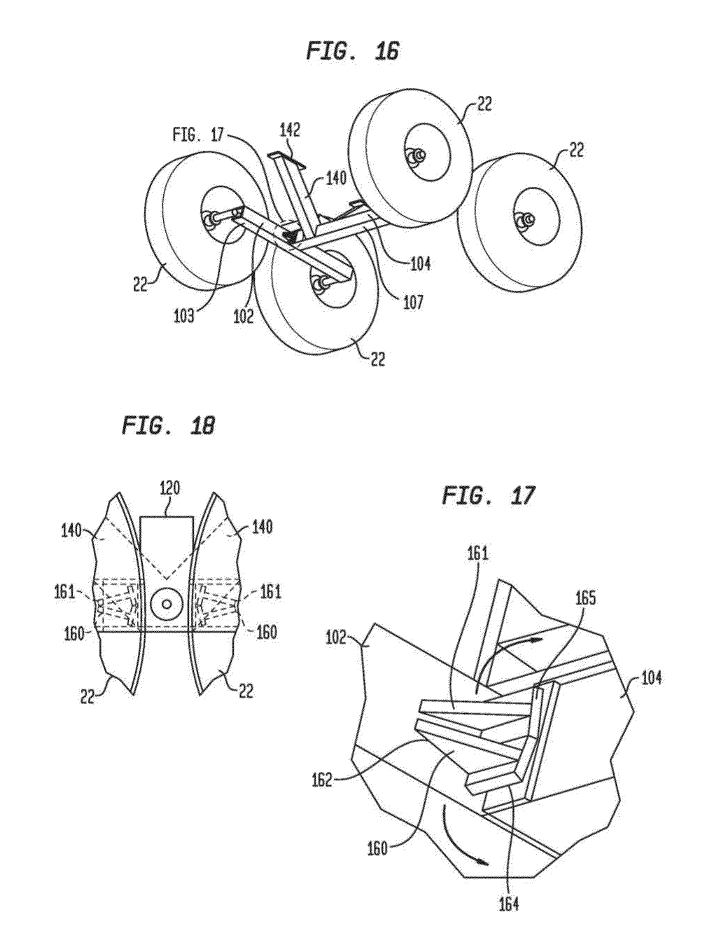

FIG. 16 is a perspective view of wheel axle assembly 100 in accordance with embodiments of the present invention. FIGS. 17 and 18 are perspective and side views of portions of wheel axle assembly 100 in accordance with embodiments of the present invention. In the embodiment illustrated in FIGS. 16-18, wheel axle assembly 100 includes wheel stops 160 and 161. In certain embodiments, wheel stops 160 and 161 are configured to limit rotational movement of axles 102 and 106 relative to axle 104. In some embodiments, wheel stops 160 and 161 prevent movement of axles 102 and 106 beyond of a certain range to prevent wheels 22 from bumping against support platform 28. In certain embodiments, wheel axle assembly 100 may include one or more wheel stops 160, 161. In the embodiment illustrated in FIGS. 16-18, a first surface 162 of a first wheel stop 160 is coupled to first axle 102. Another surface 164 of first wheel stop 160 is movable relative to second axle 104. Surface 164 of wheel stop 160 is positioned on first axle 102 such that, when lower surface 103 of first axle 102 is parallel or co-planar with lower surface 107 of second axle 104, surface 164 is positioned at an angle relative to an adjacent surface 109 of second axle 104, as illustrated in FIG. 17. In certain embodiments, surface 164 of wheel stop 160 is disposed at approximately a 12 degree angle with respect to surface 109 of second axle 104. In some embodiments, axle 102 is configured to rotate 12 degrees in one direction with respect to axle 104, and is prevented by at least wheel stop 160 from rotating further in that direction. In the embodiment illustrated in FIGS. 16-18, a second wheel stop 161 is positioned on first axle 102 adjacent first wheel stop 160 so that a surface 165 of second wheel stop 161 is disposed at approximately a 12 degree angle with respect to surface 109 of axle 104, but opposite surface 164 of first wheel stop 160. In such embodiments, axle 104 is configured to rotate no more than approximately 12 degrees in one direction (e.g., upwardly) relative to axle 102 and no more than approximately 12 degrees in the opposite direction (e.g., downwardly), providing a 24 degree range of rotation for axle 102 with respect to axle 104. In other embodiments, rotational ranges of different sizes may be provided by wheel stops 160 and 161. In certain embodiments, wheel stops 160 and 161 permit some rotation of axle 102 relative to axle 104, but prevent axle 102 from rotating so much that axle 102 or one or more of wheels 22 makes contact with support platform 28.

In certain embodiments, the amount of rotation permitted may be different based upon the shape and configuration of wheel stops 160 and 161. In the embodiment illustrated in FIG. 18, two pairs of adjacent wheel stops 160, 161 may be positioned on first axle 102, with one pair 160, 161 on one side of second axle 104 and another pair 160, 161 on the opposite side of axle 104. In some embodiments, one or more wheel stops 160, 161 may be positioned on third axle 106 to allow a limited range of rotation of axle 106 with respect to axle 104. In certain embodiments, axle 106 may rotate relative to axle 104 independent of the rotation of axle 102 relative to axle 104.

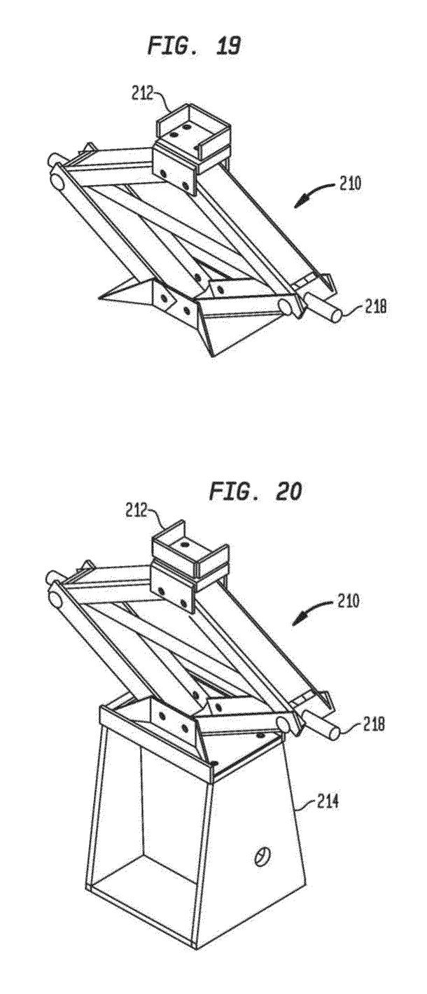

FIGS. 19 and 20 are perspective views of a scissor jack 210 that may be used with tow bar 24 of shelter system 10 in accordance with embodiments of the present invention. In certain embodiments, scissor jack 210 may be used to raise and position row bar 24. In some embodiments, it may be desirable to raise and/or support tow bar 24 to adjust and/or maintain trailer 20 in a substantially level position. In certain embodiments, the height of scissors jack 210 can be adjusted in a conventional manner by rotation of threaded rod 218. In the embodiment illustrated in FIGS. 19 and 20, an upper portion of scissors jack 210 includes a plate 212 which may mate with a portion of tow bar 24 to selectively position tow bar 24 relative to jack 210. In the embodiment illustrated in FIG. 21, scissors jack 210 includes a base 214 which may further raise the overall height of scissor jack 210.

While various embodiments have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents. The present embodiments are, therefore, to be considered in all respects as illustrative and not restrictive. Additionally, it will be appreciated that any features, components, elements, etc., described above in relation to different exemplary embodiments may be implemented together.

What is claimed is:

1. A mobile shelter system having deployed and non-deployed configurations, the shelter system comprising:
a towable trailer; and
a plurality of functional components for use in the deployed configuration, comprising:
a temperature control unit configured to output one or more of heated and cooled air; and
an electric generator configured to provide power to the temperature control unit,
wherein, in the non-deployed configuration, all of the functional components are positioned on the trailer and the system is configured to be towed over rugged terrain by an off-road vehicle.

2. The system of claim 1, wherein the plurality of functional components further comprises:
an expandable shelter having a collapsed state in the non-deployed configuration and an expanded state in the deployed configuration.

3. The system of claim 2, wherein the temperature control unit is configured to provide the one or more of heated and cooled air to an interior of the shelter in the deployed configuration.

4. The system of claim 3, wherein the functional components further comprise:
a plurality of ducts configured to connect the temperature control unit to the interior space of the shelter in the deployed configuration.

5. The system of claim 2, wherein the shelter includes an inflatable frame and the functional components further comprise:
an inflator configured to inflate the inflatable frame.

6. The system of claim 1, wherein, in the non-deployed configuration, the footprint of the system is less than approximately 88 inches by approximately 108 inches.

7. The system of claim 1, wherein the functional components further comprise:
a fuel powered heater.

8. The system of claim 1, wherein the trailer comprises a telescoping tow bar.

9. The system of claim 1, wherein the trailer comprises:
a wheel axle assembly including first, second and third axles, wherein the first and third axles are configured to rotate relative to the second axle.

10. The system of claim 1, wherein the off-road vehicle is one or more of an all-terrain vehicle (ATV) and a utility-terrain vehicle (UTV).

11. A mobile shelter system comprising:
an expandable shelter including at least one inflatable beam; and
a multi-stage inflator configured to inflate the at least one inflatable beam, the multi-stage inflator including:
a first stage inflator configured to discharge a first volume of a pressurized gas at a first pressure; and
a second stage inflator configured to discharge a second volume of the pressurized gas at a second pressure greater than the first pressure, wherein the first volume is greater than the second volume.

12. The system of claim 11, wherein the multi-stage inflator further comprises:
a control system configured to automatically switch between operation of the first stage inflator and the second stage inflator.

13. The system of claim 12, wherein the control system is configured to switch between operation of the first stage inflator and the second stage inflator after a predetermined amount of time has elapsed.

14. The system of claim 11, further comprising:
a towable trailer, wherein, in a non-deployed configuration of the system, the shelter is positioned on the trailer in a collapsed state and the inflator is positioned on the trailer.

15. The system of claim 14, further comprising:
a temperature control unit positioned on the trailer and configured to provide one or more of heated and cooled air to an interior of the shelter when the shelter is in an inflated state; and
an electric generator positioned on the trailer and configured to provide power to the temperature control unit.

16. The system of claim 11, wherein the first stage inflator is a blower.

17. The system of claim 11, wherein the second stage inflator is a compressor.

18. A mobile shelter system having a deployed configuration and a non-deployed configuration, the shelter system comprising:
an expandable shelter having a collapsed state and an expanded state;
a temperature control unit configured to provide one or more of heated and cooled air to an interior of the shelter in the expanded state;
an electric generator configured to provide power to the temperature control unit; and
a fuel powered heater configured to receive fuel stored in the generator and to provide heated air to the interior of the shelter in the expanded state.

19. The system of claim 18, further comprising:
a remote control system configured to control the temperature control unit and the fuel powered heater.

20. The system of claim 18, further comprising:
a towable trailer, wherein, in the non-deployed configuration, the shelter, the generator, the environmental control unit, and the heater are all positioned on the trailer.

21. The system of claim 20, further comprising:
a plurality of ducts configured to connect the environmental control unit to the shelter.

22. The system of claim 21, wherein the expandable shelter is an inflatable shelter, and wherein the system further comprises:
an inflator configured to inflate the expandable shelter from the collapsed state to the expanded state, wherein the inflator is positioned on the trailer in the non-deployed configuration.

23. A mobile shelter system comprising:
a towable trailer including a wheel axle assembly comprising:
a first longitudinal axle support having a first longitudinal axis and a first hole extending transverse the first longitudinal axis;
first and second wheels coupled to the first longitudinal axle support;
a lateral axle support extending substantially perpendicular to and rotatably coupled to the first longitudinal axle support such that the first and second wheels move in opposite directions when the first longitudinal axle support rotates about the lateral axle support, wherein a first end of the second axle support extends through and out of the first hole; and
a first bracket coupled to the second axle support at a first location on a first side of the first longitudinal axle support and at a second location on a second side of the first longitudinal axle support opposite the first side.

24. The system of claim 23, wherein the cross-sectional area of the first end of the lateral axle support is smaller than the cross-sectional area of another portion of the lateral axle support.

25. The system of claim 23, wherein the trailer includes a substantially planar platform positioned on the wheel axle assembly.

26. The system of claim 25, further comprising:
a plurality of arms secured to the lateral axle support, wherein a frame of the trailer is secured to the arms and the substantially planar platform secured to the frame.

27. The portable shelter system of claim 25, wherein the first and second wheels are positioned on the same side of the first longitudinal axle support.

28. The system of claim 27, further comprising:
a plurality of wheel stops secured to the first longitudinal axle support and configured to prevent the first longitudinal axle support from rotating such that either of the wheels makes contact with the platform.

29. The system of claim 23, wherein the wheel axle assembly further comprises:
a second longitudinal axle support having a second longitudinal axis and a second hole extending transverse the second longitudinal axis, wherein the lateral axle support extends substantially perpendicular to and is rotatably coupled to the second longitudinal axle support, wherein a second end of the lateral axle support extends through and out of the second hole.

30. The system of claim 29, wherein the wheel axle assembly further comprises:
a second bracket coupled to the lateral axle support at a third location on a first side of the second longitudinal axle support and at a fourth location on a second side of the second longitudinal axle support opposite the first side of the second longitudinal axle support.
